(19) United States
(12) Patent Application Publication
(10) Pub. No.: US 2004/0172345 A1
(43) Pub. Date: Sep. 2, 2004

(54) Internet billing system

(76) Inventor: Robert Green, Cheltenham (AU)

Correspondence Address: Edwin D Schindler, P O Box 966, Five Hirsch Avenue, Coram, NY, 11727-0966, US

(21) Appl. No.: 10/477,349

(22) PCT Filed: Feb. 14, 2002
(86) PCT No.: PCT/AU02/00151

(30) Foreign Application Priority Data
Mar. 2, 2001 (AU) PR 3492

(51) Int. Cl. G06F 17/60

(52) U.S. Cl. 705/30

(57) ABSTRACT

A system whereby a user can obtain access, by way of a service provider on the internet to which the user is connected and through which provider the user may be connected to one or any of a number of internet content providers which make a charge for their services, the time of connection to the, or each provider being noted and an account raised and details provided to the user.

This invention relates to an internet billing system.

There have previously been proposed internet billing systems such as that which is known as the ANI in which when a user wishes to access certain internet content, particularly that which is charged on a time basis, they download a “dialler” and, on operation, the dialler disconnects them from their normal ISP and dials a specific pre-determined telephone number. Very often, this number is at an international destination

Once the call connection was made, the user was able to view the required content but during the whole of the viewing period, he was connected to the content provider by means of a standard telephone line and was charged the normal telephone access charges together with the cost of the content provider.

On termination of the access, the call was terminated and subsequently the cost of this call appeared on his telephone bill as an international call.

The object of the invention is to provide timed internet access and billing system which overcomes the disadvantages of the previous and other systems.

The invention, in its broadest sense, comprises a system whereby a user can obtain access, by way of a service provider on the internet to which the user is connected and through which provider the user may be connected to one or any of a number of internet content providers which make a charge for their services, the time of connection to the, or each provider being noted and an account raised and details provided to the user.

It is preferred in the system, that if the account is not paid then the user's access is terminated.

The method noting the time of connection can be done either by downloading onto the user's computer a program by means of which this monitoring is effected or alternatively by using a system whereby the monitoring is effected by monitoring at the ISP level.

In order that the invention may be more readily understood and put into practice we shall describe one particular form of operation of the invention.

The operator of the system acts as an intermediary between a user and one or more providers of material to which there is an access fee on the internet.

Previously, where a content provider wished to make a charge for the use of the content, they had to take one of a number of approaches.

The first was the ANI approach referred to earlier herein where a specific connection was made by way of a direct telephone call to the content provider and the user received on his or her telephone, account charges which covered both the telephone connection, and this could often be an international call, and the provider's charges.

The second, and possibly more usual approach, was that the content provider estimated a monthly charge and this was automatically billed to a credit card account of the user.

The third was a visit by visit charge on a credit note with the billing being back to the credit note and the fourth was on the basis of the establishment of an account which may either be charged to a credit card, the details of which were stored, or by way of an invoice sent through email or by normal mail.

The options which make use of credit cards have been somewhat difficult to implement fully as many persons are still loathe to send details of their credit cards over the internet which they see as basically insecure.

With the present invention, the provider has an arrangement with the various suppliers of internet content and makes direct connection to these suppliers when this is required.

The user has an arrangement with the provider and makes a direct connection with the provider when access to a supplier of content is required and this can be done in two ways.

The first is by providing a program which is used by the user.

In order to provide security the user is provided with a password and when the program is entered, some identifying user name may be displayed, and this may preferably be the user's email address, and the password is requested.

The password is provided by the user by having the user enter an application which includes the email address of the user. The password is provided to the email address so that it is not possible for a user to give a spurious email address as, under this circumstance, the user will not receive the password.

The second is by a direct connection whereby the user logs onto the provider's site, preferably by using a distinctive or unique user name and a password.

In either case, on an acceptable password being entered, the user receives a screen which may have a number of sites available to the user and the required site may be selected.

It is also preferred that the screen has a description of the site so that when the selection is made a description of what the site contains is displayed and, preferably, also the cost of connection to the site. This may be, say, 0.50¢ or $1.00 per minute for sites of general interest up to $5.00 or even more for connection to specialised sites of specific interest, normally sites which are used by professional users.

The cost of connection to the site is preferably displayed so that the user is well aware of what the connection will cost him/her.

Then by selection of the site, the user is directly connected to the site and the site is preferably displayed in a normal browser window, such as a Microsoft Internet Explorer or Netscape Communicator window.

As long as the connection is made, a screen shows the amount of time spent viewing the site, and the system times the user's connection for the purposes of invoicing the user for this time. The initial startup screen will be available, the screen can either be set up to be visible at all times or could be shrunk onto a toolbar and simply by displaying this, the user can ascertain the status, ie connected, disconnected or other, and also the current cost for the connection. This means that the user can keep in view the cost that he/she is incurring using the particular site.

When the user disconnects from the site, the provider notes the site, the value and the time of connection.

At predetermined periods, normally directly at the end of each connection, the provider sends an emailed invoice to the email address associated with the user name and/or the password. As the email address has found to be satisfactory as the password has been obtained from this, there is reasonable certainty that the invoice has been received by the user. If there has been incorrect use of an email address, the owner of the address will receive an early indication that there has been mis-use. Payment of this invoice can either be through the internet by use of a credit card, could be payment by cheque by mail to a specified address, by direct bank transfer or could be by a pre-payment held by the provider on behalf of the user, thus reducing the credit balance of the user.

If the account is not paid within a pre-determined period, say fourteen (14) days, then the user's access will be terminated and no further connection can be made.

The termination can be such that the computer from which the request for connection is modified during set up of the original program so that it can receive a blocking message which not only prevents the program in the computer from operating, it also prevents a further copy of the program being installed and used on the same computer.

Also, if a person endeavours to obtain a password based on the same email address which is in default, then no password will be issued.

These, jointly give good security for the system.

The system provides benefits to each party.

The user has a direct connection to the content provider without having to go through the normal telephone system, they can access the content through a normal internet browser.

He/she does not have to pay any telephone call charges other than the cost of entering the Internet thus making the cost of the access very much cheaper than might otherwise be the case, particularly if an international call was involved.

The system includes a comprehensive accounting package which provides the user with detailed accounting information regarding his/her use of the system and provides the provider with all accounting details of all users and the content provider with full accounting information of all the users connecting by way of the system and obtaining information therefrom.

The content provider receives a benefit in that the users do not have to provide a credit card number, which inhibits use, nor do they have to pay international telephone calls, which is again an inhibiting factor for connection to the provider.

The service provider benefits from a commission arrangement with the content provider and takes responsibility for payment of content providers and receiving funds from the users.

Generally, the arrangement with content providers will enable any loss to be taken into account and as any such loss would generally be relatively small, and the provision of content is rather ephemeral, the cost to the content providers and to the provider of the service is relatively little and can readily be borne.

The provider who operates the service, of course, obtains the benefit of receiving commission on material which passes therethrough.

The invention thus provides a simple method of connecting users with content providers with benefits to all parties.

Whilst we have described one particular arrangement of the system these particular ways of carrying it out can vary widely.

Generally, security is important and we have described the use of a user name and password to enter the interconnection system itself and there may be further user names and passwords as far as connecting to any individual information provider is concerned.

Any or all such variations are deemed to be within the scope of the invention.

We claim:

1. A system whereby a user can obtain access, by way of a service provider on the internet to which the user is connected and through which provider the user may be connected to one or any of a number of internet content providers which make a charge for their services, the time of connection to the, or each provider being noted and an account raised and details provided to the user.

2. A system as claimed in claim 1 wherein, in order to make the connection, the user first downloads software provided by the service provider.

3. A system as claimed in claim 1 wherein the user connects directly to the service provider through the ISP with the connection being monitored.

4. A system as claimed in claim 2 or claim 3 wherein the user must enter at least one of Username and Password before the connection is permitted.

5. A system as claimed in claim 4 wherein once the connection to the provider is made, the user has the option to be connected to one or any of a number of content providers which act in association with the service provider, to provide specific content on a pay for access basis.

6. A system as claimed in claim 5 wherein the content providers provide the service provider with an indication of costs incurred and the service provider charges the user for at least these costs.

7. A system as claimed in claim 6 wherein the service provider charges the user with the charges made by the content provider(s) and the content provider pays a commission to the service provider.

8. A system as claimed in claim 6 wherein the service provider charges the user with the charges made by the content provider(s) together with a commission to the service provider.

9. A system as claimed in claim 7 or claim 8 wherein the user is charged by way of an invoice which is forwarded to the user subsequent to the completion of the connection.

10. A system as claimed in claim 9 wherein if the invoice is not paid within a prescribed time period, the user's access to the system is terminated.

11. A system as claimed in claim 7 or claim 8 wherein the user's charges are debited against a credit account held by the provider.

12. A system as claimed in claim 11 wherein if the credit account is not replenished when exhausted, the user's access to the system is terminated.

13. A system whereby a user can obtain access, by way of a service provider on the internet to which the user is connected and through which provider the user may be connected to one or any of a number of internet content providers, the time of connection to the, or each provider being noted and means being provided whereby the content provider(s) receive details of the connection and the cost of the connection charged to the user, the provider has full details of all connections made by the user and the user in an account provided subsequently or otherwise is provided with details of all connections made.
